(19) United States
(12) Patent Application Publication
(10) Pub. No.: US 2007/0254610 A1
(43) Pub. Date: Nov. 1, 2007

(54) Device, system and method of reception chain adaptation

(76) Inventor: Sharon Levy, Hadera (IL)

Correspondence Address: PEARL COHEN ZEDEK LATZER, LLP, 1500 BROADWAY, 12TH FLOOR, NEW YORK, NY, 10036, US

(21) Appl. No.: 11/414,239

(22) Filed: May 1, 2006

(51) Int. Cl. H04B 17/02

(52) U.S. Cl. 455/136

(57) ABSTRACT

Some embodiments of the invention provide devices, systems and methods of reception chain adaptation. For example, an apparatus in accordance with an embodiment of the invention includes: an Automatic Gain Control unit to adaptively modify a property of a component of a reception chain of a wireless communication device based on an estimated interference power level at one or more points along said reception chain.

### BACKGROUND OF THE INVENTION

In the field of wireless communication, a wireless communication device may include a reception chain having multiple stages, for example, a Low Noise Amplifier (LNA), one or more filters, and one or more Programmable Gain Amplifiers (PGAs). Interfering devices, e.g., “blockers”, may generate strong interfering signals which may introduce non-linearity to a wireless communication signal intended for reception by the wireless communication device.

In order to improve the linearity of the received signal, the wireless communication device may set a gain of the reception chain, e.g., using an Automatic Gain Control (AGC) unit. Unfortunately, the AGC unit may use a filtered or modified signal as a basis for AGC setting, thereby resulting in non-linear signal and/or compression of one of more stages, e.g., compression of one or more PGAs.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system utilizing reception chain adaptation in accordance with an embodiment of the invention;

FIG. 2 is a schematic block diagram illustration of three graphs power spectral density of an incoming signal and interference; and

FIG. 3 is a schematic flow-chart of a method of coordination among multiple transceivers in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVETION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee (TM), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Although portions of the discussion herein may relate, for demonstrative purposes, to a reception chain or a receiver which may be included in a wireless communication device or a wireless communication station, embodiments of the invention are not limited in this regard. For example, reception chain adaptation in accordance with some embodiments of the invention may be used in accordance with various other machines or apparatuses which may include a reception chain or a receiver, or machines able to receive wireless signals, and may not be or may not include a computing platform or a communication device.

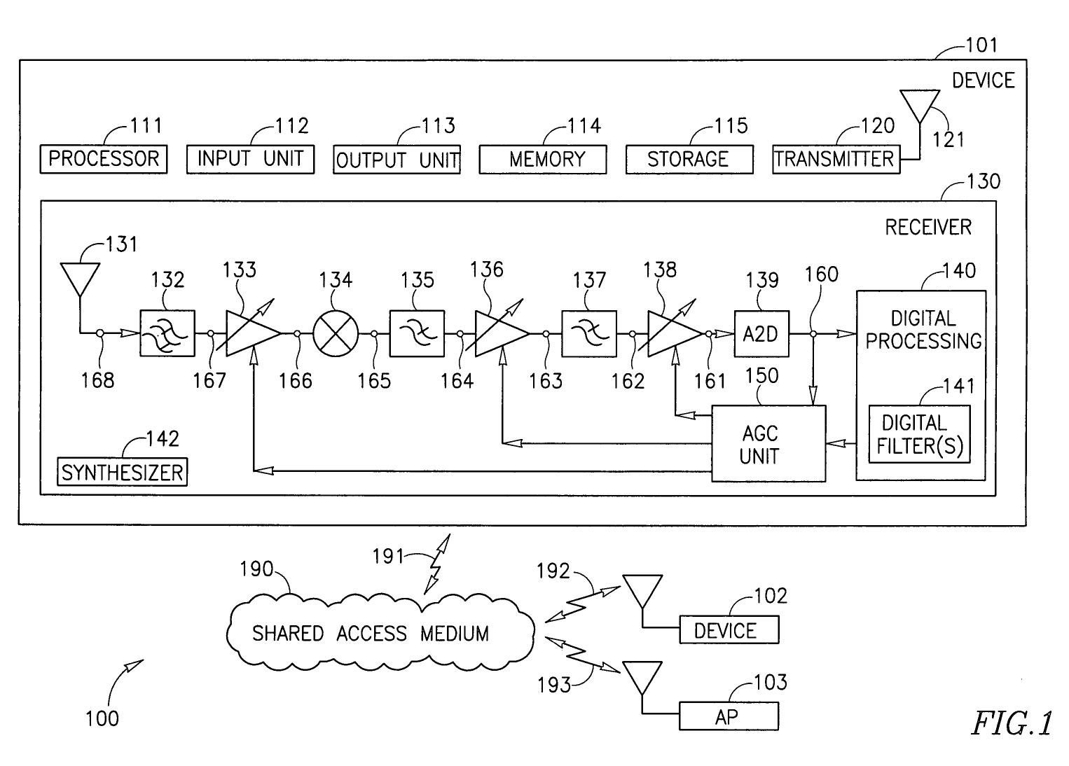

FIG. 1 schematically illustrates a block diagram of a wireless communication system 100 utilizing reception chain adaptation in accordance with an embodiment of the invention. System 100 may include one or more wireless communication devices, for example, a wireless communication device 101. System 100 may optionally include other wireless devices, for example, a wireless communication device 102 and an Access Point (AP) 103. Device 101, device 102 and device 103 may communicate using a shared access medium 190, for example, through wireless communication links 191, 192 and 193, respectively.

In some embodiments, for example, device 101, device 102 and AP 103 may be able to communicate in accordance with a wireless communication standard or protocol, for example, IEEE 802.11 standard. In other embodiments, for example, device 101 and AP 103 may be able to communicate in accordance with a first wireless communication standard or protocol (e.g., IEEE 802.11 standard), whereas device 102 may be able to communicate with other wireless devices in accordance with a second wireless communication standard or protocol (e.g., IEEE 802.16 standard).

Device 101 may include, for example, a processor 111, an input unit 112, an output unit 113, a memory unit 114, a storage unit 115, a transmitter 120 and a receiver 130. Device 101 may optionally include other suitable hardware components and/or software components. In some embodiments, the components of device 101 may be enclosed in, for example, a common housing, packaging, or the like.

Processor 111 may include, for example, a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 may, for example, process signals and/or data transmitted and/or received by device 101.

Input unit 112 may include, for example, a keyboard, a keypad, a mouse, a touch-pad, a stylus, a microphone, or other suitable pointing device or input device. Output unit 113 may include, for example, a Cathode Ray Tube (CRT) monitor or display unit, a Liquid Crystal Display (LCD) monitor or display unit, a screen, a monitor, a speaker, or other suitable display unit or output device.

Memory unit 114 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Storage unit 115 may include, for example, a hard disk drive, a floppy disk drive, a Compact Disk (CD) drive, a CD-ROM drive, or other suitable removable or non-removable storage units. Memory unit 114 and/or storage unit 115 may, for example, store data transmitted and/or received by device 101.

Transmitter 120 may include, for example, a wireless Radio Frequency (RF) transmitter able to transmit wireless RF signals, e.g., through an antenna 121. Receiver 130 may include, for example, a wireless RF receiver able to receive wireless RF signals, e.g., through an antenna 131. In some embodiments, for example, transmitter 120 and/or receiver 130 may be implemented using a transceiver or a transmitter-receiver, or one or more units able to perform separate or integrated functions of transmitting and/or receiving wireless communication signals, blocks, frames, transmission streams, packets, messages and/or data.

Antenna 121 and/or antenna 131 may include an internal and/or external RF antenna, for example, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data. In some embodiments, optionally, antenna 121 and antenna 131 may be implemented using a common or single antenna, e.g., a transmit/receive antenna.

Receiver 120 may include a multi-stage reception chain, which may include, for example, antenna 131, a Surface Acoustic Wave (SAW) filter/duplexer 132, a Low Noise Amplifier (LNA) 133, a mixer 134, a roofing filter 135 (e.g., implemented as a separate unit of receiver 120 or as part of mixer 134), a first Programmable Gain Amplifier (PGA) 136, a filter 137 (e.g., an adaptive filter), a second PGA 138, and an Analog to Digital (A2D) converter 139, a digital processing unit 140 (e.g., including one or more digital filter(s) 141), and an AGC unit 150. Receiver 120 may include additional and/or other components.

In some embodiments, for example, antenna 131 may receive a wireless communication signal, e.g., an incoming RF signal. Optionally, the incoming signal may pass through the SAW filter/duplexer 132, for example, if reception antenna 131 and transmission antenna 121 are implemented using a common antenna element. The filtered signal may pass through the LNA 133, for example, which may amplify the signal. The amplified signal may pass through mixer 134, which may reduce or modify the frequency of the signal, and through the roofing filter 135, which may reduce the passband of the signal. The first PGA 136 may amplify the signal, which may pass through adaptive filter 137, and may be further amplified by the second PGA 138. The amplified signal may be converted from analog to digital using the A2D converter 139. The digital signal may be processed by the digital processing unit 140, for example, the signal may be further filtered using digital filter(s) 141.

In some embodiments, the digital signal generated by A2D converted 139, or a portion or sample thereof, may be received and analyzed by the AGC unit 150, e.g., for determination or estimation of interference power level(s). In other embodiments, a fully or partially processed digital signal, e.g., processed by digital processing unit 140, or a portion or sample thereof, may be received and analyzed by the AGC unit 150, e.g., for determination or estimation of interference power level(s).

In accordance with some embodiments of the invention, the AGC unit 150 may selectively set or adaptively modify one or more parameters, characteristics or modes of operation of components of the reception chain of receiver 120, based on a “blockers” map which may be generated. For example, the AGC unit 150 may adaptively set or modify the operation or characteristics of LNA 133, PGA 136 and/or PGA 138. This may be performed, for example, by taking into account a “blockers” map, which may be generated based on information about the signal power level measured or estimated at one or more points, portions or nodes across the reception chain of receiver 120, e.g., at one or more of points 160-168. Accordingly, the AGC unit 150 may adaptively configure or dynamically reconfigure properties or parameters of components of the reception chain of receiver 120, for example, taking into account interference created by interfering devices or “blockers”, e.g., by device 102.

In one embodiment, for example, the signal power level may be measured at one or more of points 160-168, for example, at point 160 and at point 168. In another embodiment, the signal power level may be measured at one of points 160-168 (e.g., at point 160), and based on the measurement, the signal power level at one or more other points may be estimated or calculated. For example, the signal power level at point 161 may be estimated or calculated based on the measured signal power level at point 160 and based on a known functionality or effect of the A2D converter 139; the signal power level at point 162 may be estimated or calculated based on the calculated signal power level at point 161 and based on a known functionality or effect of the second PGA 138; and so on. In yet another embodiment, one or more signal power measurements may be used in combination with one or more signal power estimations or calculations. In some embodiments, for example, based on measurement of Relative Signal Strength Indicator (RSSI), power levels may be calculated as a function of frequency, for example, corresponding to substantially the entire reception band or to a portion thereof. For example, power levels at one or more points 160-168 along the reception chain may be measured or calculated, and gain settings or other parameters of the reception chain may be modified or configured based on the power levels.

The multiple measurements, estimations or calculations of signal power levels may be used to generate a representation of signal power levels at one or more of points 160-168. The representation may include or may utilize, for example, one or more graphs, maps, blockers maps, charts, tables, lookup tables, or the like. Based on the representation, for example, the AGC unit 150 may determine that a certain interference exists at certain portions of the spectrum or around certain frequencies, and may take into account such determined interference in order to adaptively configure the operation or functionality of components of receiver 120.

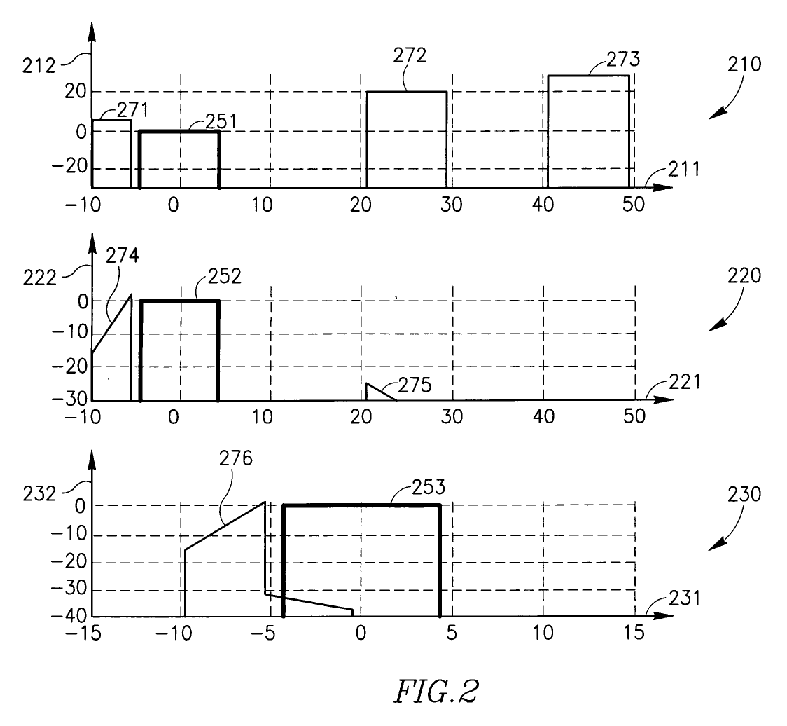

Reference is made to FIG. 2, which schematically illustrates three graphs 210, 220 and 230 of Power Spectral Density (PSD) of an incoming signal and interference, in accordance with some embodiments of the invention. Horizontal axis 211, horizontal axis 221, and horizontal axis 231 indicate, for example, a frequency or a frequency offset, e.g., in MHz; whereas vertical axis 212, vertical axis 222, and vertical axis indicate, for example, a relative power (e.g., in dB)

In some embodiments, for example, graph 210 may correspond, for example, to power spectral density levels which may be measured or estimated at point 167 of FIG. 1. For example, line 251 may correspond to power level of a signal intended for reception, whereas lines 271-273 may correspond to power level of interference, e.g., generated by one or more blockers.

In some embodiments, for example, graph 220 may correspond, for example, to power spectral density levels which may be measured or estimated at point 161 of FIG. 1. For example, line 252 may correspond to power level of a signal intended for reception, whereas lines 274-275 may correspond to power level of interference, e.g., generated by one or more blockers.

In some embodiments, for example, graph 230 may correspond, for example, to power spectral density levels which may be measured or estimated at point 160 of FIG. 1. For example, line 253 may correspond to power level of a signal intended for reception, whereas line 276 may correspond to power level of interference, e.g., generated by one or more blockers.

Graphs 210, 220 and 230 may be used as a blockers map, for example, a representation of blockers, level of blockers, and/or frequency of blockers. The blockers map may be utilized, for example, by the AGC unit 150 of FIG. 1, in order to configure or modify the Intercept Point (IP) (e.g., second order IP or third order IP) of receiver 120 or a component thereof, the Noise Figure (NF) of receiver 120 or a component thereof, the linearity or non-linearity of receiver 120 or a component thereof, the amplification or gain of receiver 120 or a component thereof, a level of current or voltage provided to one or more components of receiver 120, or the like. In some embodiments, for example, the adaptive setting of properties, or the re-configuration of components, of receiver 120 may be used to avoid or reduce compression of one or more stages of the reception chain.

In some embodiments, optionally, based on the blockers map, power detector(s) may be added at one or more of points 160-168. Information of power detection may be, for example, passed to the digital processing unit 140 for utilization in the digital processing, or may be utilized in the analog domain, e.g., by closing the AGC loop in the analog domain. In other embodiments, the center frequency used by receiver 120 may vary in time or may be modified over time, and the AGC unit 150 may be set according to a target reception frequency; this may be used, for example, in conjunction with device 101 able to utilize “frequency hopping”.

For example, graph 210 demonstrates relative power measured at, or estimated to be at, a first sampling point along the reception chain, e.g., at point 167 of FIG. 1; graph 220 demonstrates relative power measured at, or estimated to be at, a second sampling point along the reception chain, e.g., at point 161 of FIG. 1; and graph 230 demonstrates relative power measured at, or estimated to be at, a third sampling point along the reception chain, e.g., at point 160 of FIG. 1.

As demonstrated in graph 210, a strong interference may exist around a frequency offset of 45 MHz. Due to the strong interference, the first PGA 136 of FIG. 1 may be compressed, and non-linearity may be introduced to the incoming signal.

Referring again to FIG. 1, in some embodiments, strong interference may result from, for example, strong blockers, e.g., due to uncoordinated communication by device 102, due to the location or proximity of device 101 relative to device 102, or the like. In some embodiments, for example, the interference may be substantially non-varying, generally non-varying, or varying slowly in time. For example, the interference level may be related to the distance of device 101 (which may intend to receive the incoming signal) from device 102 (which may generate the interference). In some embodiments, the interference frequency may be related to frequency band(s) allocated to various communication operators; for example, device 102 may utilize a frequency band which may interfere with the frequency band used by device 101.

Based on the blockers map, the AGC unit 150 may set or modify parameters of one or more components of receiver 120, in order to achieve an improved or optimal tradeoff between non-linearity and noise floor (e.g., a sum of NF and quantization noise), and/or to reduce power consumption by receiver 120 or component(s) thereof.

In some embodiments, the reception chain of receiver 120 may be periodically set or tuned (e.g., using a synthesizer 142) to a predetermined bandwidth (e.g., approximately 20 MHz) around various center frequencies. This may allow, for example, an environmental “sniffing” of possible blockers and analysis of possible scenarios, e.g., by measurement or estimation of signal power and/or interference power at various frequency bands or portions of the spectrum, and construction of a blockers map. The blockers map may be used by AGC unit 150 in order to selectively modify or adaptively configure receiver 120 or component(s) thereof, e.g., the IP, the NF, the linearity and/or the amplification of receiver 120 or component(s) thereof

In some embodiments, optionally, AGC unit 150 may adaptively configure one or more components of receiver 120, for example, by switching among multiple modes of operation of such component(s), e.g., a first mode of operation in which the component (e.g., the LNA 133) operates in accordance with a first set of properties or under a first voltage, a second mode of operation in which the component (e.g., the LNA 133) operates in accordance with a second set of properties or under a second voltage, or the like. For example, based on the blockers map, the AGC unit 150 may selectively switch the operation of LNA 133 from first mode in which the LNA 133 adds a gain of fifteen dB, to a second mode in which the LNA 133 adds a gain of six dB, or the like.

In some embodiments, for example, based on the blockers map, the AGC unit 150 may modify operational parameters of multiple components of receiver 120, e.g., of LNA 133, PGA 136 and/or PGA 138, for example, in order to achieve a certain total gain for these components and/or in order to achieve a certain total gain for receiver 120.

In some embodiments, for example, based on the blockers map, the AGC unit 150 may determine that a strong interference exists, e.g., an interference having a high absolute power due to proximity to a strong blocker. Accordingly, for example, the AGC unit 150 may determine to decrease (or to eliminate) the amplification or gain produced by earlier stages in the reception chain (e.g., by LNA 133), and to increase the amplification or gain produced by later stages in the reception chain (e.g., by PGA 136 and/or PGA 138).

In some embodiments, device 101 may include multiple reception chains. For example, a first reception chain or components thereof may be adaptively configured by the AGC unit 150 during a time period in which the second reception chain is silent, non-operational, or non-communicative.

In some embodiments, for example, device 101 may include multiple antennas, which may be used for reception and/or transmission. For example, the reception chain of receiver 120 or components thereof may be adaptively configured by the AGC unit 150 during a time period in which a first antenna is used for reception and a second antenna is non-operational, non-communicative, not used for reception, or used for transmission.

Some embodiments may be used, for example, in conjunction with devices or units (e.g., device 101 or receiver 120) operating in accordance with Long Term Evolution (LTE) standards or protocols. For example, a wireless communication standard or protocol used by device 101 or receiver 120 may utilize a relatively narrow frequency band, e.g., a bandwidth of approximately two MHz. In some embodiments, a blocker may operate and may generate interference outside of the narrow frequency band in use by receiver 120. Synthesizer 142 may thus offset the frequency used by receiver 120, and optionally, only the In-phase (I) path of a twenty MHz bandwidth may be used, e.g., to reduce power consumption. In some embodiments, for example, receiver 120 may dynamically switch from a zero Intermediate Frequency (IF) to an offset frequency (e.g., a low negative IF) in order to generate the blockers map and/or to adaptively configure one or more stages of the reception chain.

In some embodiments, receiver 120 may periodically “sniff” or analyze one or more frequencies or frequency bands in order to detect possible blockers. In one embodiment, for example, the analyzed frequencies or frequency bands may be pre-defined, or may periodically be “sniffed” according to a pre-defined frequency interval. In another embodiment, for example, receiver 120 may selectively “sniff” or analyze certain frequencies or frequency bands according to one or more criteria. For example, some embodiments may include analysis of licensed frequency bands, analysis of unlicensed frequency bands, analysis of frequency bands selected based on a certain served technology or communication standard, analysis of frequency bands selected based on interference levels or expected power consumption, or the like.

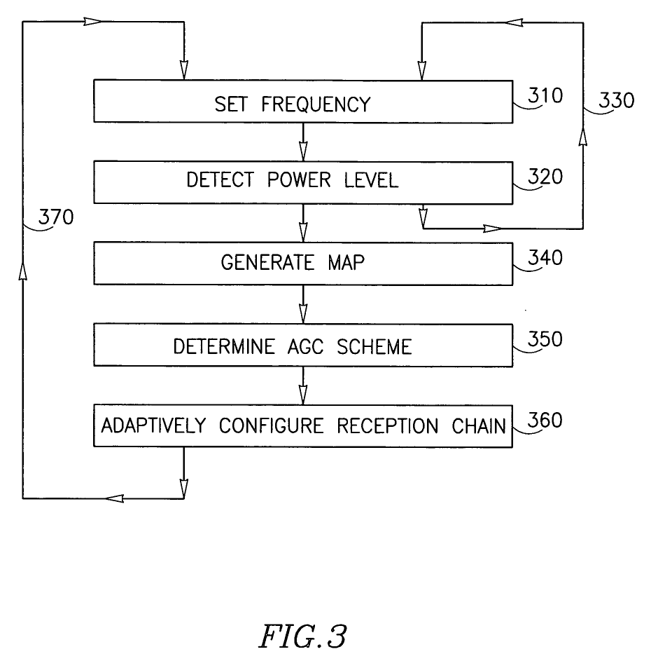

FIG. 3 is a schematic flow-chart of a method of adapting a reception chain in accordance with an embodiment of the invention. Operations of the method may be implemented, for example, by system 100 of FIG. 1, by device 101 of FIG. 1, by receiver 120 of FIG. 1, by AGC unit 150 of FIG. 1, and/or by other suitable units, devices, and/or systems.

As indicated at box 310, the method may optionally include, for example, setting a reception chain to a pre-defined frequency or frequency band. This may include, for example, setting a center frequency and a bandwidth, e.g., based on a pre-defined criteria, at pre-defined frequency intervals, or the like.

As indicated at box 320, the method may optionally include, for example, detecting a power level (e.g., of interference, or a signal intended for reception) at the set frequency or frequency band.

As indicated by arrow 330, the method may optionally include, for example, repeating the operations of boxes 310 and 320, e.g., periodically, a pre-defined number of times, at pre-defined time intervals, until a certain portion of the spectrum is scanned, or the like.

As indicated at box 340, the method may optionally include, for example, generating a map, e.g., a blockers map or an interference map representing power levels of interference, and optionally of a signal to be received, as a function of frequency.

As indicated at box 350, the method may optionally include, for example, determining an AGC scheme or strategy based on the generated map.

As indicated at box 360, the method may optionally include, for example, adaptively configuring one or more components of the receiver based on the generated map. This may include, for example, setting or modifying gain or amplification of one or more stages of the reception chain. In some embodiments, the adaptive configuration may be performed in order to achieve optimal or improved reception parameters, e.g., amplification, linearity, NF, IP, or the like.

As indicated by arrow 370, the method may optionally include, for example, repeating the above operations, e.g., periodically, at pre-defined time intervals, on demand, if one or more conditions are met (e.g., if a Signal to Noise Ratio (SNR) is smaller than a threshold value), or the like.

Other operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by device 101 of FIG. 1, by processor 111 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 114 or storage unit 115), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
an Automatic Gain Control unit to adaptively modify a property of a component of a reception chain of a wireless communication device based on an estimated interference power level at one or more points along said reception chain.

2. The apparatus of claim 1, wherein said one or more points comprises at least a point selected from the group consisting of:
a point between a reception antenna of said reception chain and an input of an Analog to Digital converter of said reception chain;
a point between a reception antenna of said reception chain and an input of a Low Noise Amplifier of said reception chain; and
a point between a reception antenna of said reception chain and an input of a Programmable Gain Amplifier of said reception chain.

3. The apparatus of claim 1, further comprising:
a synthesizer to tune said reception chain to a center frequency,
wherein said Automatic Gain Control unit is to determine whether interference exists at said center frequency.

4. The apparatus of claim 1, wherein said Automatic Gain Control unit is to periodically generate a representation of a power level of at least one interference signal and a power level of a signal intended for reception, and to adaptively modify said property based on said representation.

5. The apparatus of claim 4, wherein said Automatic Gain Control unit is to adaptively modify said property based on said representation and in accordance with a target reception frequency.

6. The apparatus of claim 4, further comprising an adaptive filter to filter a frequency bandwidth corresponding to a frequency offset, wherein said Automatic Gain Control unit is to generate said representation based on a power level of one or more signals of said frequency bandwidth.

7. The apparatus of claim 1, wherein said Automatic Gain Control unit is to adaptively modify said property in accordance with a target characteristic selected from the group consisting of: a pre-defined amplification of said reception chain, a pre-defined Noise Floor of said reception chain, and a predefined linearity of said reception chain.

8. The apparatus of claim 1, wherein said Automatic Gain Control unit is to measure a Relative Signal Strength Indicator at a first point on a digital path of said reception chain, and to calculate a power level at a second point on an analog path of said reception chain based on a gain attributed to one or more components between said first and second points.

9. The apparatus of claim 1, wherein said property comprises a gain of said component, and wherein said component is selected from a group consisting of: a Low Noise Amplifier, and a Programmable Gain Amplifier.

10. A method comprising:
adaptively modifying a property of a component of a reception chain of a wireless communication device based on an estimated interference power level at one or more points along said reception chain.

11. The method of claim 10, comprising: estimating a power level of interference corresponding to at least a point selected from the group consisting of:
a point between a reception antenna of said reception chain and an input of an Analog to Digital converter of said reception chain;
a point between a reception antenna of said reception chain and an input of a Low Noise Amplifier of said reception chain; and
a point between a reception antenna of said reception chain and an input of a Programmable Gain Amplifier of said reception chain.

12. The method of claim 10, further comprising:
tuning said reception chain to a center frequency; and
determining whether interference exists at said center frequency.

13. The method of claim 10, further comprising:
periodically generating a representation of a power level of at least one interference signal and a power level of a signal intended for reception; and
adaptively modifying said property based on said representation.

14. The method of claim 13, comprising:
adaptively modifying said property based on said representation and in accordance with a target reception frequency.

15. The method of claim 13, comprising:
filtering a frequency bandwidth corresponding to a frequency offset; and
generating said representation based on a power level of one or more signals of said frequency bandwidth.

16. The method of claim 10, comprising:
adaptively modifying said property in accordance with a target characteristic selected from a group consisting of: a pre-defined amplification of said reception chain, a pre-defined Noise Floor of said reception chain, and a pre-defined linearity of said reception chain.

17. The method of claim 10, comprising:
measuring a Relative Signal Strength Indicator at a first point on a digital path of said reception chain; and
calculating a power level at a second point on an analog path of said reception chain based on a gain attributed to one or more components between said first and second points.

18. A wireless communication system comprising:
a wireless communication device comprising:
a dipole antenna able to receive wireless communication signals; and
an Automatic Gain Control unit to adaptively modify a property of a component of a reception chain of a wireless communication device based on an estimated interference power level at one or more points along said reception chain.

19. The wireless communication system of claim 18, wherein said one or more points comprises at least a point selected from the group consisting of:
a point between a reception antenna of said reception chain and an input of an Analog to Digital converter of said reception chain;
a point between a reception antenna of said reception chain and an input of a Low Noise Amplifier of said reception chain; and
a point between a reception antenna of said reception chain and an input of a Programmable Gain Amplifier of said reception chain.

20. The wireless communication system of claim 18, wherein said Automatic Gain Control unit is to periodically generate a representation of a power level of at least one interference signal and a power level of a signal intended for reception, and to adaptively modify said property based on said representation.
